(19) United States
(12) Patent Application Publication
(10) Pub. No.: US 2026/0246405 A1
(43) Pub. Date: Aug. 20, 2026

(54) MOTOR DRIVE CONTROL DEVICE, MOTOR UNIT, AND MOTOR DRIVE CONTROL METHOD

(71) Applicant: MINEBEA MITSUMI Inc., Nagano (JP)

(72) Inventor: Daisuke Shimizu, Nagano (JP)

(21) Appl. No.: 19/544,157

(22) Filed: Feb. 19, 2026

(30) Foreign Application Priority Data
Feb. 20, 2025 (JP) 2025-025537

(51) Int. Cl. H02P 23/18; H02P 23/14

(52) U.S. Cl. CPC H02P 23/18; H02P 23/14

(57) ABSTRACT

A motor drive control device includes a drive circuit configured to drive a motor based on a drive control signal, and a control circuit configured to calculate an operation amount of the motor such that the motor rotates at a target rotation speed, set an advance angle value such that the advance angle value increases as a rotation speed of the motor increases, and output the drive control signal according to the operation amount at a timing determined based on the advance angle value and a rotational position of a rotor of the motor. The control circuit sets a reference value α each corresponding to the rotation speed as the advance angle value, and sets a value greater than the reference value as the advance angle value when a degree of increase in the rotation speed satisfies a predetermined condition.

### CROSS REFERENCE TO RELATED APPLICATIONS

This application claims priority benefit of Japanese Patent Application No. 2025-025537 filed on Feb. 20, 2025. The above-referenced application is hereby incorporated herein by reference in its entirety.

### TECHNICAL FIELD

The present invention relates to a motor drive control device, a motor unit, and a motor drive control method.

### BACKGROUND ART

As a technique for driving a motor with high efficiency, advance angle control is known. The advance angle control adjusts a timing (phase) when a voltage is applied to a coil of the motor such that a phase of an induced voltage (phase induced voltage) generated in the coil of the motor matches a phase of a coil current (phase current).

For example, in a sensorless drive control method to drive a motor without providing a position sensor such as a Hall element, advance angle control is known. The advance angle control is a technique using the zero crossing of the induced voltage as a reference to estimate the time until the next zero crossing occurs and switches the energization between the coils at a phase-advanced timing relative to the estimated next zero crossing (see Patent Document 1).

### CITATION LIST

### Patent Literature

Patent Document 1: JP 3965395 B

### SUMMARY OF INVENTION

### Technical Problem

When performing advance angle control, it is necessary to appropriately determine the advance angle value according to the rotation speed of the motor. Here, the advance angle value is a value specifying the timing when voltage is applied to the coil of the motor, and is, for example, a value specifying the amount of advance of the energization phase relative to the next zero crossing of the induced voltage. Generally, the advance angle value needs to be set to a larger value as the rotation speed of the motor increases. On the other hand, the optimum advance angle value differs depending on the motor to be driven, the load, and the like.

Therefore, the inventor of the present application investigated finding an appropriate advance angle value according to the rotation speed of the motor by conducting experiments or the like in advance, and storing correspondence relationship information such as a table or function showing a correspondence relationship between the rotation speed and the advance angle value in a storage device within the motor drive control device.

This allows the motor drive control device to read an appropriate advance angle value from the storage device according to the rotation speed of the motor, and perform energization control of the motor at a timing based on the read advance angle value, thereby making it possible to drive the motor efficiently.

However, the inventor of the present application has discovered through his investigations that when a motor is driven using a sensorless drive control method, in a transient state where the motor suddenly accelerates, simply setting the advance angle value using the above-mentioned method may result in an insufficient advance angle, making it impossible to appropriately detect the zero crossing of the induced voltage.

When the zero crossing of the induced voltage cannot be appropriately detected in a sensorless drive control method, a rotational position of a rotor cannot be estimated, and the coil of the motor cannot be energized at the appropriate timing, which may result in insufficient torque and the motor losing synchronization. Furthermore, even in motor drive control methods that use position sensors such as Hall elements, when energization is not performed at the appropriate timing, excessive current may flow through the coil, damaging not only the motor but also surrounding electronic components.

The present invention is intended to solve the above-mentioned problems, and an object of the present invention is to operate a motor stably even when the motor is suddenly accelerated.

### Solution to Problem

A motor drive control device according to a representative embodiment of the present invention includes: a drive circuit configured to drive a motor based on a drive control signal for controlling driving of the motor; and a control circuit configured to calculate an operation amount of the motor such that the motor rotates at a target rotation speed, set an advance angle value such that the advance angle value increases as a rotation speed of the motor increases, and output the drive control signal according to the operation amount at a timing determined based on the advance angle value and a rotational position of a rotor of the motor, in which the control circuit sets a reference value each corresponding to the rotation speed as the advance angle value, and sets a value greater than the reference value as the advance angle value when a degree of increase in the rotation speed satisfies a predetermined condition.

### Advantageous Effects of Invention

According to one aspect of the present invention, it is possible to operate the motor stably even when the motor is suddenly accelerated.

### BRIEF DESCRIPTION OF DRAWINGS

FIG. 1 is a diagram illustrating a configuration of a motor unit equipped with a motor drive control device according to a first embodiment.

FIG. 2 is a diagram for describing a method for setting an advance angle value of a motor by the motor drive control device according to the first embodiment.

FIG. 3 is a diagram illustrating an example of a functional block configuration of a control circuit according to the first embodiment.

FIG. 4 is a flowchart illustrating an example of a flow of processing for correcting an advance angle value according to the first embodiment.

FIG. 5 is a flowchart illustrating an example of a flow of processing when correction of an advance angle value according to the first embodiment is stopped.

FIG. 6 is a diagram illustrating a configuration of a motor unit equipped with a motor drive control device according to a second embodiment.

FIG. 7 is a diagram illustrating an example of a functional block configuration of a control circuit according to the second embodiment.

### DESCRIPTION OF EMBODIMENTS

### 1. Overview of Embodiments

First, an outline of a representative embodiment of the invention disclosed in the present application will be described. In the following description, as an example, reference signs in the drawings corresponding to the components of the invention are illustrated in parentheses.

A motor drive control device (10) according to a representative embodiment of the present invention includes: a drive circuit (2) configured to drive a motor (4) based on a drive control signal (Sd) for controlling driving of the motor, and a control circuit (1) configured to calculate an operation amount (Md) of the motor such that the motor rotates at a target rotation speed, set an advance angle value (θ) such that the advance angle value increases as a rotation speed of the motor increases, and output the drive control signal according to the operation amount at a timing determined based on the advance angle value and a rotational position of a rotor of the motor, in which the control circuit sets a reference value each corresponding to the rotation speed as the advance angle value, and sets a value greater than the reference value as the advance angle value when a degree of increase in the rotation speed satisfies a predetermined condition.

In the motor drive control device according to [1] above, the control circuit may determine that the degree of increase in the rotation speed satisfies the predetermined condition when at least one of a first condition that an increase rate of the target rotation speed is equal to or greater than a first threshold value and a second condition that an increase rate of the rotation speed is equal to or greater than a second threshold value is satisfied.

In the motor drive control device according to [1] or [2] above, the control circuit may include a target rotation speed acquisition unit (11) configured to acquire the target rotation speed, a position detection unit (14) configured to detect the rotational position of the rotor, a rotation speed calculation unit (13) configured to calculate the rotation speed, a state determination unit (16) configured to determine whether the degree of increase in the rotation speed satisfies the predetermined condition based on at least one of the rotation speed calculated by the rotation speed calculation unit and the target rotation speed, an operation amount calculation unit (12) configured to calculate the operation amount such that the rotation speed calculated by the rotation speed calculation unit matches the target rotation speed, an advance angle value setting unit (17) configured to set the advance angle value according to the rotation speed calculated by the rotation speed calculation unit, and a drive control signal generation unit (15) configured to generate the drive control signal based on the operation amount, determine a timing for energization switching between coils of the motor based on the set advance angle value and the rotational position of the rotor detected by the position detection unit, and output the drive control signal based on the determined timing. The advance angle value setting unit may set the reference value (α) corresponding to the rotation speed calculated by the rotation speed calculation unit as the advance angle value when the state determination unit does not determine that the degree of increase in the rotation speed satisfies the predetermined condition, and set a value corrected to be greater than the reference value as the advance angle value when the state determination unit determines that the degree of increase in the rotation speed satisfies the predetermined condition.

In the motor drive control device according to [3] above, the advance angle value setting unit (17) may include a storage unit (20) configured to store correspondence relationship information (201) indicating a correspondence relationship between the rotation speed and the reference value, and a correction value (β) for correcting the reference value, a reference value calculation unit (18) configured to calculate the reference value corresponding to the rotation speed calculated by the rotation speed calculation unit based on the correspondence relationship information, and an advance angle value output unit (19) configured to output the reference value calculated by the reference value calculation unit as the advance angle value when the state determination unit does not determine that the degree of increase in the rotation speed satisfies the predetermined condition, and configured to output a value obtained by adding the correction value stored in the storage unit to the reference value calculated by the reference value calculation unit as the advance angle value when the state determination unit determines that the degree of increase in the rotation speed satisfies the predetermined condition.

In the motor drive control device according to [4] above, the state determination unit may determine whether the rotation speed is stable, and the advance angle value output unit may decrease the correction value in a stepwise manner when the state determination unit determines that the rotation speed is stable in a state where the advance angle value output unit outputs the value obtained by adding the correction value to the reference value as the advance angle value.

A motor unit (100, 100A) according to an embodiment of the present invention includes: the motor drive control device (10, 10A) according to any one of [1] to [5] above; and the motor (4).

A motor drive control method according to an embodiment of the present invention includes: a first step of calculating an operation amount of a motor such that the motor rotates at a target rotation speed; a second step of setting an advance angle value such that the advance angle value increases as a rotation speed of the motor increases; and a third step of generating a drive control signal for controlling driving of the motor according to the operation amount, and outputting the drive control signal at a timing determined based on the advance angle value and a rotational position of a rotor of the motor, in which the second step may include a fourth step of setting a reference value each corresponding to the rotation speed as the advance angle value, and a fifth step (S11 to S14) of setting a value corrected to be greater than the reference value set in the fourth step as the advance angle value when a degree of increase in the rotation speed satisfies a predetermined condition.

### 2. Specific Examples of Embodiments

Specific examples of embodiments of the present invention will be described below with reference to the drawings. In the following description, components common to the respective embodiments are denoted by the same reference signs, and repeated descriptions thereof are omitted.

### First Embodiment

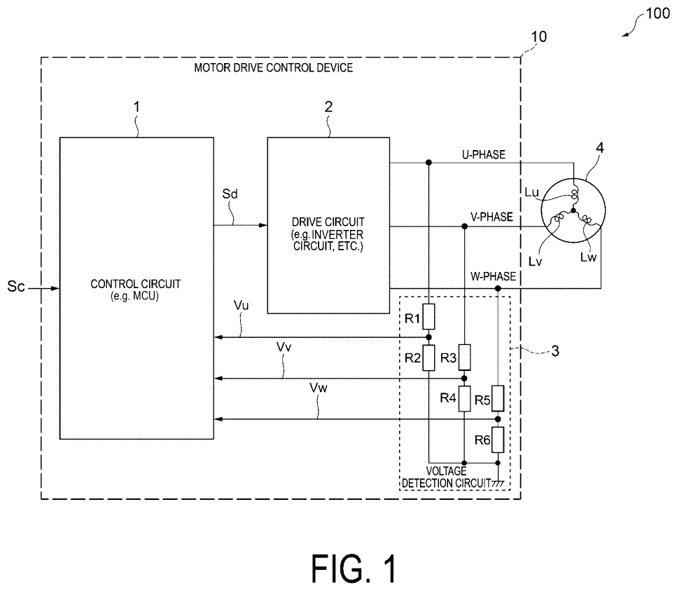

FIG. 1 is a diagram illustrating a configuration of a motor unit 100 including a motor drive control device 10 according to a first embodiment.

The motor unit 100 illustrated in FIG. 1 can be mounted on a flying device such as a drone, and applied as a drive source for rotor blades (propellers) of the flying device. The motor unit 100 includes, for example, a motor 4 and the motor drive control device 10.

The motor 4 is a motor having at least one coil. For example, the motor 4 is a brushless DC motor having three-phase (U-phase, V-phase, and W-phase) coils (windings) Lu, Lv, and Lw. The coils Lu, Lv, and Lw are connected in a Y-connection (star connection), for example. The terminals of each of the coils Lu, Lv, and Lw opposite to the neutral point are connected to a drive circuit 2. For example, a rotor blade (not illustrated) is coupled to the output shaft of the motor 4 via a reducer (not illustrated) or the like.

The motor drive control device 10 is a device that controls the drive of the motor 4. The motor drive control device 10 controls the drive of the motor 4 such that the motor 4 rotates at a target rotation speed specified by a drive command signal Sc, for example, by using a sensorless drive control method that drives the motor without providing a position sensor such as a Hall element.

More specifically, the motor drive control device 10 includes a control circuit 1, a drive circuit 2, and a voltage detection circuit 3.

The drive circuit 2 is a circuit for driving the motor 4 based on a drive control signal Sd output from the control circuit 1. The drive control signal Sd is a signal for controlling the drive of the motor 4, and is, for example, a pulse width modulation (PWM) signal.

The drive circuit 2 includes, for example, an inverter circuit (for example, H bridge circuit) having a plurality of transistors as switch elements. The inverter circuit switches between the connection destinations of the coil of the motor 4 between a DC voltage and a ground potential in response to a PWM signal serving as the drive control signal Sd, thereby switching between the directions of the motor current and rotating the motor 4.

The drive circuit 2 may have a pre-drive circuit for driving each transistor constituting the inverter circuit described above based on the drive control signal Sd. Furthermore, a sense resistor for detecting the current flowing through the motor 4 may be connected to the inverter circuit.

The voltage detection circuit 3 is a circuit configured to detect a back electromotive force Vbef generated in each of the coils Lu, Lv, and Lw of the motor 4. The voltage detection circuit 3 divides the voltages of each of the coils Lu, Lv, and Lw of the motor 4 and outputs the divided voltages. For example, as illustrated in FIG. 1, the voltage detection circuit 3 includes a resistive voltage divider circuit connected between each of the coils Lu, Lv, and Lw and the ground potential. Specifically, the voltage detection circuit 3 includes resistors R1 and R2 connected in series between one terminal of the coil Lu on the opposite side of the neutral point and the ground potential, resistors R3 and R4 connected in series between one terminal of the coil Lv on the opposite side of the neutral point and the ground potential, and resistors R5 and R6 connected in series between one terminal of the coil Lw on the opposite side of the neutral point and the ground potential.

In the voltage detection circuit 3, when the coil Lu is in a non-energized state, a voltage Vu at the node where the resistors R1 and R2 are commonly connected is input to the control circuit 1 as the back electromotive force of the U-phase coil Lu. When the coil Lv is in a non-energized state, a voltage Vv at the node where the resistors R3 and R4 are commonly connected is input to the control circuit 1 as the back electromotive force of the V-phase coil Lv. When the coil Lw is in a non-energized state, a voltage Vw at the node where the resistors R5 and R6 are commonly connected is input to the control circuit 1 as the back electromotive force of the W-phase coil Lw.

The control circuit 1 is a circuit for controlling the overall operation of the motor drive control device 10. In the first embodiment, the control circuit 1 is a program processing device having a configuration. In the configuration, a processor such as a CPU, various storage devices such as a RAM, a ROM, and a flash memory, and peripheral circuits such as a counter (timer), an A/D conversion circuit, a D/A conversion circuit, a clock generation circuit, and an input/output interface circuit are connected to each other via a bus or dedicated lines. For example, the control circuit 1 is a microcontroller unit (MCU).

The control circuit 1 and the drive circuit 2 may be configured to be packaged as a single semiconductor integrated circuit (IC), or may be packaged as separate integrated circuits and mounted on a circuit board, and electrically connected to each other on the circuit board.

The control circuit 1 calculates an operation amount Md of the motor 4 such that the motor 4 rotates at a target rotation speed Nt. For example, the control circuit 1 acquires the voltages Vu, Vv, and Vw of the coils of the non-energized phase from the voltages Vu, Vv, and Vw detected by the voltage detection circuit 3 as the back electromotive force Vbef, and calculates a rotation speed (actual rotation speed) Nr of the motor 4 based on the detection result of the zero crossing of the back electromotive force Vbef. The control circuit 1 generates the operation amount Md by closed-loop control such that the rotation speed (actual rotation speed) Nr of the motor 4 matches the target rotation speed Nt specified by the drive command signal Sc.

Furthermore, the control circuit 1 performs advance angle control based on the detection result of the zero crossing of the back electromotive force. Specifically, the control circuit 1 sets an advance angle value θ, the advance angle value θ being a value specifying the timing when a voltage is applied to the coils Lu, Lv, and Lw of the motor 4, such that the advance angle value θ increases as the rotation speed Nr of the motor 4 increases.

The control circuit 1 generates a drive control signal Sd according to the operation amount Md and outputs the drive control signal Sd at a timing based on the advance angle value θ. Specifically, the control circuit 1 determines the timing of energizing each of the coils Lu, Lv, and Lw based on the detection result of the zero crossing of the back electromotive force and the advance angle value θ, and outputs a drive control signal Sd.

The control circuit 1 switches between the calculation methods of the advance angle value θ depending on the degree of increase in the rotation speed of the motor 4. The calculation method of the advance angle value θ by the control circuit 1 will be outlined below with reference to the drawings.

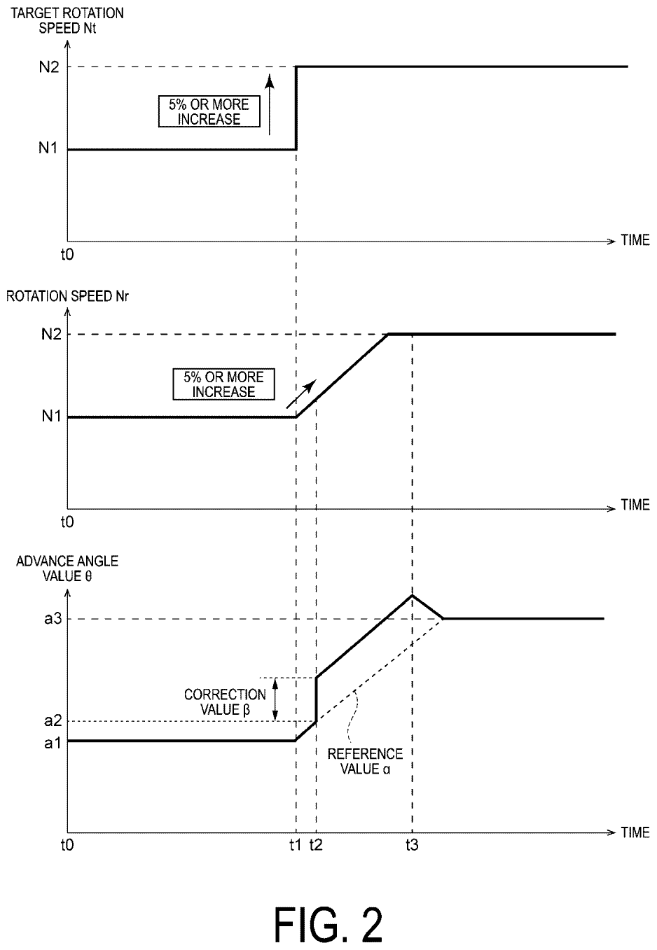

FIG. 2 is a diagram for describing a method for setting the advance angle value θ of the motor 4 by the motor drive control device 10 according to the first embodiment.

In FIG. 2, the upper part of the page shows a graph of the change over time in the target rotation speed Nt, the middle part of the page shows a graph of the change over time in the rotation speed Nr, and the lower part of the page shows a graph of the change over time in the advance angle value θ. In the graph in the upper part of the page of FIG. 2, the vertical axis represents the target rotation speed Nt, and the horizontal axis represents time. In the graph in the middle part of the page of FIG. 2, the vertical axis represents the rotation speed Nr, and the horizontal axis represents time. In the graph in the lower part of the page of FIG. 2, the vertical axis represents the advance angle value θ, and the horizontal axis represents time.

The control circuit 1 sets a value (hereinafter also referred to as a “reference value”) α corresponding to each rotation speed (target rotation speed Nt or rotation speed Nr) as the advance angle value θ, and when the degree of increase in the rotation speed satisfies a predetermined condition, sets a value greater than the reference value α as the advance angle value θ.

For example, when at least one of a first condition that an increase rate RNt of the target rotation speed Nt is equal to or greater than a first threshold value Rth1 and a second condition that an increase rate RNr of the rotation speed Nr is equal to or greater than a second threshold value Rth2 is satisfied, the control circuit 1 determines that the degree of increase in the rotation speed satisfies the predetermined condition.

Here, the increase rate RNt of the target rotation speed Nt in the first condition refers to a value based on the ratio or difference between the set target rotation speed Nt(n) and the target rotation speed Nt(n−1) set immediately before. For example, the increase rate RNt of the target rotation speed Nt may be (Nt(n)−Nt(n−1))/Nt(n−1)×100[%]. In the first embodiment, as an example, the first threshold value Rth1 is set to 5%.

The increase rate RNr of the rotation speed Nr in the second condition refers to an increase amount in the rotation speed per unit time. For example, when the rotation speed at time ta is “Nra” and the rotation speed at time tb, which is Δt (e.g., 10 ms) after time ta, is “Nrb”, the increase rate RNr of the rotation speed Nr may be (Nrb−Nra)/Nra×100[%]. In the first embodiment, as an example, the second threshold value Rth2 is set to 5%.

In the first embodiment, it is assumed that the control circuit 1 determines that the degree of increase in the rotation speed satisfies the predetermined condition when both the first condition and the second condition are satisfied. A specific method for setting the advance angle value θ will be described below using the case of FIG. 2 as an example.

For example, as illustrated in FIG. 2, it is assumed that at time t0, the target rotation speed Nt is set to N1, and the motor 4 rotates at a rotation speed Nr =N1. At this time, the control circuit 1 sets a reference value a1 corresponding to the rotation speed N1 as the advance angle value θ, and controls the drive of the motor 4 using this advance angle value θ (=α=a1).

Thereafter, it is assumed that at time t1, the target rotation speed Nt increases from “N1” to “N2” and the increase rate of the target rotation speed Nt exceeds 5% (first threshold value Rth1). In this case, the control circuit 1 determines that the first condition is satisfied.

At time t1, the target rotation speed Nt becomes N2, and the control circuit 1 generates a drive control signal Sd such that the rotation speed Nr of the motor 4 becomes N2, thereby accelerating the rotation speed Nr of the motor 4. At this time, the control circuit 1 changes the advance angle value θ in accordance with the rotation speed Nr of the motor 4. That is, after time t1 illustrated in FIG. 2, the control circuit 1 increases the reference value α in accordance with an increase in the rotation speed Nr.

Then, it is assumed that at time t2, which is 10 ms after time t1, the increase rate of the rotation speed Nr of the motor 4 exceeds 5% (second threshold value Rth2). In this case, the control circuit 1 determines that the second condition is satisfied.

At time t2, since both the first condition and the second condition are satisfied, the control circuit 1 determines that the degree of increase in the rotation speed satisfies the predetermined conditions, and sets a value greater than the reference value α as the advance angle value θ. For example, the control circuit 1 sets the value obtained by adding a correction value β to a reference value a2 corresponding to the rotation speed at time t2 as the advance angle value θ (=a2+β). Thereafter, the control circuit 1 increases the reference value α in accordance with an increase in the rotation speed Nr. Accordingly, when the motor 4 is suddenly accelerated, the control circuit 1 drives the motor 4 based on the advance angle value θ greater than the reference value α by the correction value β.

Thereafter, when the rotation speed Nr of the motor 4 reaches the target rotation speed Nt (=N2) and the rotation speed Nr stabilizes at time t3, the control circuit 1 reduces the advance angle value θ to the reference value α corresponding to the rotation speed N2. For example, the control circuit 1 decreases the correction value β in a stepwise manner, thereby reducing the advance angle value θ to a reference value a3 corresponding to the rotation speed N2.

Next, the functional blocks of the control circuit 1 for implementing the motor drive control function including the method for determining the advance angle value θ described above will be described.

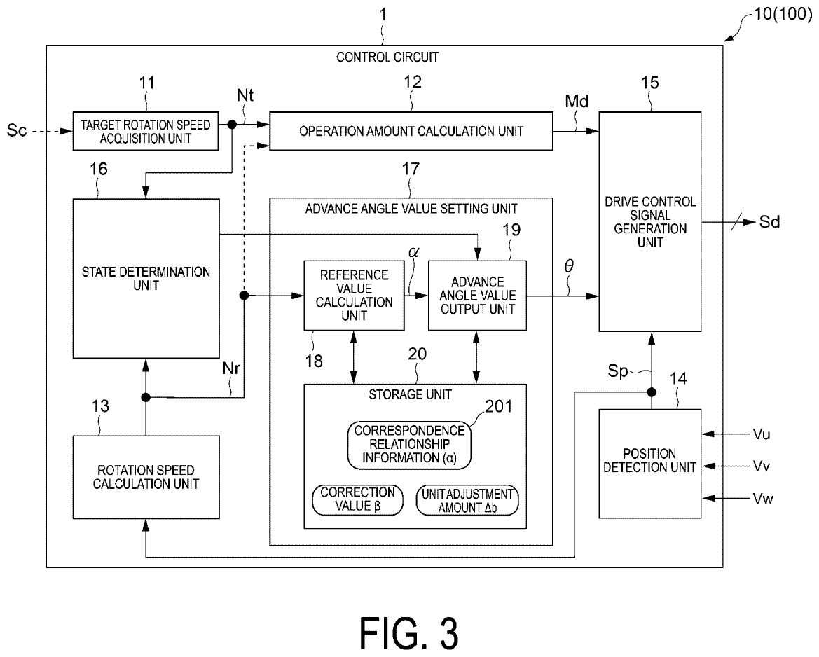

FIG. 3 is a diagram illustrating an example of a functional block configuration of the control circuit 1 according to the first embodiment.

As illustrated in FIG. 3, the control circuit 1 includes, as functional blocks for implementing the above-mentioned functions, for example, a target rotation speed acquisition unit 11, an operation amount calculation unit 12, a rotation speed calculation unit 13, a position detection unit 14, a drive control signal generation unit 15, a state determination unit 16, and an advance angle value setting unit 17.

The above-mentioned functional units of the control circuit 1 are implemented, for example, by program processing of the MCU serving as the control circuit 1. Specifically, the processor constituting the MCU serving as the control circuit 1 performs various calculations according to the programs stored in the memory to control the peripheral circuits constituting the MCU, thereby implementing each of the functional units described above.

The target rotation speed acquisition unit 11 is a functional unit configured to acquire the target rotation speed Nt. When the drive command signal Sc is input to the control circuit 1, the target rotation speed acquisition unit 11 acquires information on the target rotation speed Nt included in the drive command signal Sc. For example, when the drive command signal Sc is a PWM signal having a duty ratio corresponding to the specified target rotation speed Nt, the target rotation speed acquisition unit 11 measures the duty ratio of the PWM signal serving as the drive command signal Sc and outputs the rotation speed corresponding to the measured duty ratio as the target rotation speed Nt.

The position detection unit 14 is a functional unit configured to detect the rotational position of the rotor of the motor 4. The position detection unit 14 detects the zero crossings of the back electromotive forces Vu, Vv, and Vw based on, for example, a known zero crossing detection method, and generates and outputs a position detection signal Sp indicating the rotational position of the rotor.

The rotation speed calculation unit 13 is a functional unit configured to calculate the rotation speed Nr of the motor 4 (rotor). For example, the rotation speed calculation unit 13 calculates and outputs the rotation speed Nr of the motor 4 using a known calculation method based on the position detection signal Sp.

The operation amount calculation unit 12 is a functional unit configured to calculate the operation amount Md such that the rotation speed Nr calculated by the rotation speed calculation unit 13 matches the target rotation speed Nt.

When the control circuit 1 performs speed feedback control as a drive control method for the motor, the operation amount calculation unit 12 calculates the operation amount Md, for example, by PI control calculation or PID control calculation, such that the difference between the rotation speed Nr calculated by the rotation speed calculation unit 13 and the target rotation speed Nt approaches zero.

Furthermore, when the control circuit 1 performs open-loop speed control as a drive control method for the motor, the operation amount calculation unit 12 calculates the operation amount Md corresponding to the target rotation speed Nt. For example, correspondence relationship information such as a table or function showing a correspondence relationship between the target rotation speed Nt and the operation amount Md may be stored in advance in a storage unit (not illustrated) within the control circuit 1, and the operation amount calculation unit 12 may determine and output the operation amount Md corresponding to the acquired target rotation speed Nt with reference to the correspondence relationship information stored in the storage unit. According to this, the operation amount calculation unit 12 can calculate the operation amount Md such that the rotation speed Nr matches the target rotation speed Nt.

The drive control signal generation unit 15 is a functional unit configured to generate the drive control signal Sd. The drive control signal generation unit 15 generates a PWM signal having a duty ratio according to the operation amount Md calculated by the operation amount calculation unit 12, and outputs the PWM signal as a drive control signal Sd. For example, when the operation amount Md is a value specifying a duty ratio, the drive control signal generation unit 15 generates, as the drive control signal Sd, a PWM signal having a duty ratio specified by the operation amount Md.

The drive control signal generation unit 15 generates the drive control signal Sd based on the operation amount Md using the method described above, and outputs the drive control signal Sd through advance angle control. Specifically, the drive control signal generation unit 15 determines a timing for energization switching between the coils Lu, Lv, and Lw of the motor 4 based on the advance angle value θ set by the advance angle value setting unit 17, which will be described later, and the rotational position of the rotor detected by the position detection unit 14, and outputs the drive control signal Sd based on the determined timing. For example, the drive control signal generation unit 15 outputs the drive control signal Sd such that current is applied to the target coil at a timing when the electrical angle is advanced by the advance angle value θ from the rotational position of the rotor identified by the position detection signal Sp.

The state determination unit 16 is a functional unit configured to determine the state of change in the rotation speed of the motor 4. The state determination unit 16 determines whether the degree of increase in the rotation speed Nr satisfies a predetermined condition based on at least one of the rotation speed Nr calculated by the rotation speed calculation unit 13 and the target rotation speed Nt.

Specifically, the state determination unit 16 determines whether the first condition (the increase rate RNt of the target rotation speed Nt is equal to or greater than the first threshold value Rth1) is satisfied based on the target rotation speed Nt. For example, the state determination unit 16 calculates the increase rate RNt of the target rotation speed Nt (for example, RNt=(Nt(n)−Nt(n−1))/Nt(n−1)×100[%]) using the above-mentioned method, and determines whether the increase rate of the target rotation speed Nt is equal to or greater than the first threshold value Rth1 (=5[%]).

Furthermore, the state determination unit 16 determines whether the second condition (the increase rate of the rotation speed Nr is equal to or greater than the second threshold value Rth2) is satisfied based on the rotation speed Nr. For example, the state determination unit 16 calculates the increase rate RNr of the rotation speed Nr (for example, RNr=(Nrb−Nra)/Nra×100[%]) and determines whether the increase rate of the rotation speed Nr is equal to or greater than the second threshold value Rth2 (=5[%]).

When both the first condition and the second condition are satisfied, the state determination unit 16 determines that the degree of increase in the rotation speed Nr satisfies the predetermined condition.

Furthermore, the state determination unit 16 determines whether the rotation speed Nr is stable. The state determination unit 16 determines that the rotation speed Nr is stable, for example, when the rotation speed Nr(n) is within a predetermined range (for example, within 5%) relative to the rotation speed Nr(n−1) from a predetermined time ago (for example, 10 ms).

Alternatively, the state determination unit 16 may determine that the rotation speed Nr is stable when, after updating the target rotation speed Nt, the duty ratio indicated by the updated operation amount Md matches the duty ratio of the actual drive control signal Sd, and the rotation speed Nr(n) is within a predetermined range relative to the rotation speed Nr(n-1) from a predetermined time ago.

The advance angle value setting unit 17 is a functional unit configured to set the advance angle value θ. The advance angle value setting unit 17 sets the advance angle value θ based on the rotation speed Nr of the motor 4 and the determination result of the state determination unit 16. Specifically, when the state determination unit 16 does not determine that the degree of increase in the rotation speed Nr satisfies a predetermined condition, the advance angle value setting unit 17 sets the reference value α corresponding to the rotation speed Nr calculated by the rotation speed calculation unit 13 as the advance angle value θ (θ=α). On the other hand, when the state determination unit 16 determines that the degree of increase in the rotation speed Nr satisfies the predetermined condition, the reference value α is corrected to be greater than the reference value α, and the value (α+β) is set as the advance angle value θ (θ=α+β). More specifically, as illustrated in FIG. 3, the advance angle value setting unit 17 includes a reference value calculation unit 18, an advance angle value output unit 19, and a storage unit 20.

The storage unit 20 is a functional unit configured to store various parameters necessary for calculating the advance angle value θ. The storage unit 20 stores, for example, correspondence relationship information 201 indicating a correspondence relationship between the rotation speed Nr and the reference value α, a correction value β for correcting the reference value α, and a unit adjustment amount Δb for adjusting the correction value β.

The correspondence relationship information 201 is information such as a table (look-up table) or a function. In the table, the reference value α is associated with each rotation speed Nr. The function represents the relationship between the rotation speed Nr and the reference value α. In the correspondence relationship information 201, the reference value α is set to increase as the rotation speed increases. Note that the reference value α does not need to be different for each rotation speed in the correspondence relationship information 201, and the reference value α may be associated with each predetermined range of the rotation speed. That is, the reference value α may be set to a value that differs in a stepwise manner for each predetermined range of the rotation speed.

As described above, the correction value β is a value for correcting the reference value α, and is, for example, a fixed value that does not depend on the rotation speed. The correction value β may be set appropriately depending on the application to which the motor unit 100 is applied. The unit adjustment amount Δb is a unit amount for adjusting the correction value β. The unit adjustment amount Δb is, for example, an electrical angle of 1 degree.

The reference value calculation unit 18 is a functional unit configured to calculate a reference value α of the advance angle value. The reference value calculation unit 18 calculates the reference value α corresponding to the rotation speed Nr calculated by the rotation speed calculation unit 13 based on the correspondence relationship information 201 stored in the storage unit 20. For example, when the correspondence relationship information 201 is a table, the reference value calculation unit 18 determines the reference value α by referring to the table using the rotation speed Nr as an index and reading out the reference value α corresponding to the rotation speed Nr from the table.

The advance angle value output unit 19 is a functional unit configured to output the set advance angle value θ. When the state determination unit 16 does not determine that the degree of increase in the rotation speed Nr satisfies the predetermined condition, the advance angle value output unit 19 outputs the reference value α calculated by the reference value calculation unit 18 as the advance angle value θ (θ=α).

On the other hand, when the state determination unit 16 determines that the degree of increase in the rotation speed Nr satisfies the predetermined condition, the advance angle value output unit 19 outputs the value (α+β) obtained by adding the correction value β stored in the storage unit 20 to the reference value α calculated by the reference value calculation unit 18 as the advance angle value θ.

Furthermore, in a state where the advance angle value output unit 19 outputs the value (α+β) obtained by adding the correction value β to the reference value α as the advance angle value θ, when the state determination unit 16 determines that the rotation speed Nr is stable, the advance angle value output unit 19 decreases the correction value β in a stepwise manner. For example, the advance angle value output unit 19 decreases the correction value β in a stepwise manner by a unit adjustment amount Δb, thereby reducing the advance angle value θ to the reference value α.

Next, the flow of processing of the method for determining the advance angle value θ by the control circuit 1 according to the first embodiment will be described. First, the flow of processing when correcting the advance angle value θ will be described.

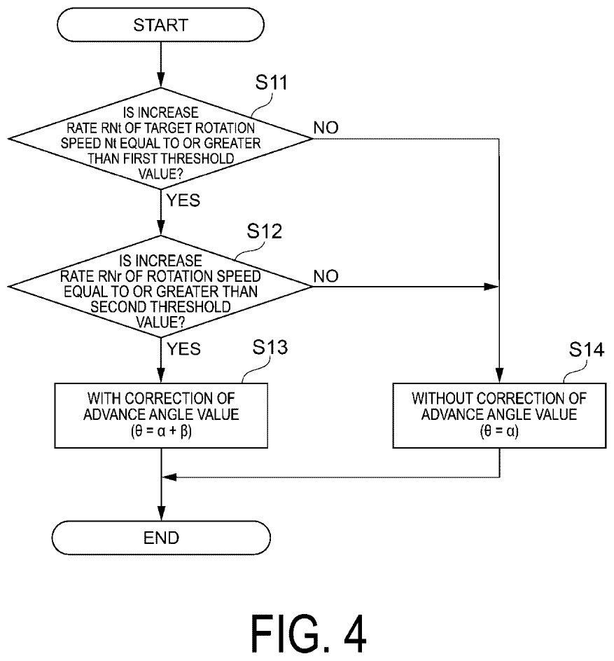

FIG. 4 is a flowchart illustrating an example of the flow of processing for correcting the advance angle value θ according to the first embodiment.

For example, in a state where the motor drive control device 10 sets the advance angle value θ to a reference value α corresponding to the rotation speed Nr of the motor 4 (θ =α) and drives the motor 4, the control circuit 1 monitors the drive command signal Sc.

Specifically, the control circuit 1 determines whether the increase rate RNt of the target rotation speed Nt specified by the drive command signal Sc is equal to or greater than the first threshold value Rth1 (=5%) (step S11). When the increase rate RNt of the target rotation speed Nt is smaller than the first threshold value Rth1 (step S11: NO), the control circuit 1 does not correct the advance angle value θ (step S14). That is, the advance angle value θ is determined by the reference value α according to the target rotation speed Nt.

On the other hand, when the increase rate RNt of the target rotation speed Nt is equal to or greater than the first threshold value Rth1 (step S11: YES), the control circuit 1 determines that the first condition is satisfied and determines whether the increase rate RNr of the rotation speed Nr is equal to or greater than the second threshold value Rth2 (=5%) (step S12). When the increase rate RNr of the rotation speed Nr is smaller than the second threshold value Rth2 (step S12: NO), the control circuit 1 does not correct the advance angle value θ (step S14).

When the increase rate RNr of the rotation speed Nr is equal to or greater than the second threshold value Rth2 (step S12: YES), the control circuit 1 determines that both the first condition and the second condition are satisfied, and corrects the advance angle value θ (step S13). That is, the control circuit 1 sets the advance angle value θ to the sum (α+β) of the reference value α and the correction value β.

Next, the flow of processing when correction of the advance angle value θ is stopped will be described.

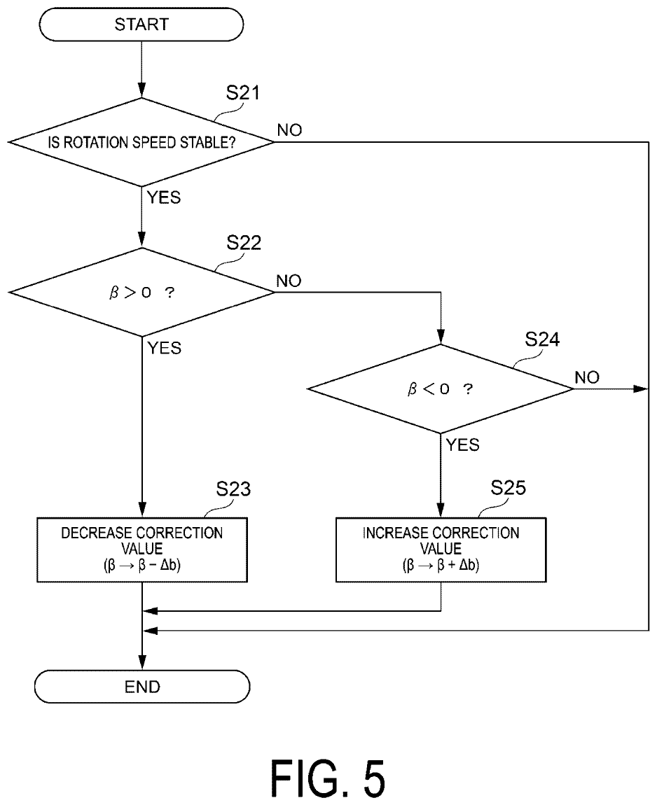

FIG. 5 is a flowchart illustrating an example of the flow of processing when correction of the advance angle value θ according to the first embodiment is stopped.

For example, in a state where the advance angle value θ is being corrected by the processing for correcting the advance angle value θ described above, the control circuit 1 monitors the drive command signal Sc and performs processing for stopping the correction of the advance angle value θ.

Specifically, the control circuit 1 first determines whether the rotation speed Nr of the motor 4 is stable (step S21). For example, as described above, after updating the target rotation speed Nt, the state determination unit 16 determines whether the duty ratio indicated by the updated operation amount Md matches the duty ratio of the actual drive control signal Sd, and whether the rotation speed Nr(n) is within a predetermined range relative to the rotation speed Nr(n−1) from a predetermined time ago. When the rotation speed Nr of the motor 4 is not stable (step S21: NO), the control circuit 1 continues to correct the advance angle value θ (θ=α+β).

When the rotation speed Nr of the motor 4 is stable (step S21: YES), the control circuit 1 (advance angle value output unit 19) determines whether the correction value β is greater than 0 (zero) (step S22). When the correction value β is greater than 0 (step S22: YES), the control circuit 1 decreases the correction value β (step S23). Specifically, as described above, the advance angle value output unit 19 reduces the correction value β by the unit adjustment amount Δb (β→β−Δb).

When the correction value β is not greater than 0 (step S22: NO), the control circuit 1 (advance angle value output unit 19) determines whether the correction value β is smaller than 0 (step S24). When the correction value β is smaller than 0 (step S24: YES), the control circuit 1 increases the correction value β (step S25). Specifically, the advance angle value output unit 19 increases the correction value β by the unit adjustment amount Δb (β→β+Δb).

On the other hand, when the correction value β is not smaller than 0 (step S24: NO), the control circuit 1 determines that the correction value β is 0, and stops correcting the advance angle value θ. Thereafter, the control circuit 1 starts the above-described processing of FIG. 4.

As described above, in the motor drive control device 10 according to the first embodiment, when the control circuit 1 performs advance angle control on the motor 4, the control circuit 1 sets the reference value α corresponding to each rotation speed as the advance angle value θ, and when the degree of increase in the rotation speed satisfies a predetermined condition, the control circuit 1 sets a value (α+β) greater than the reference value α as the advance angle value θ.

According to this, when the motor 4 is suddenly accelerated, the advance angle value is set to a value greater than the normal value (reference value α), such that the motor drive control device 10 can perform energization switching between the coils Lu, Lv, and Lw of the motor 4 at the appropriate timing, thereby making it possible to stabilize the operation of the motor 4. In other words, in a typical motor drive control device employing a sensorless drive control method, when the motor suddenly accelerates, with a normal advance angle value, the advance angle is insufficient, making it impossible to detect the zero crossing of the induced voltage, which may cause the motor to lose synchronization. In contrast, the motor drive control device 10 according to the first embodiment can avoid insufficient advance angle even during sudden acceleration of the motor, thereby enabling the zero crossing of the induced voltage to be detected appropriately and making it possible to stabilize the operation of the motor.

Furthermore, as described above, the control circuit 1 determines that the degree of increase in the rotation speed Nr satisfies the predetermined condition when at least one of the first condition that the increase rate RNt of the target rotation speed Nt is equal to or greater than the first threshold value Rth1 and the second condition that the increase rate RNr of the rotation speed Nr is equal to or greater than the second threshold value Rth2 is satisfied.

This makes it possible to appropriately detect a state where the motor is suddenly accelerating.

Furthermore, in the control circuit 1, as described above, when the state determination unit 16 does not determine that the degree of increase in the rotation speed satisfies the predetermined condition, the advance angle value setting unit 17 sets the reference value α corresponding to the rotation speed Nr calculated by the rotation speed calculation unit 13 as the advance angle value θ, and when the state determination unit 16 determines that the degree of increase in the rotation speed satisfies the predetermined condition, the advance angle value setting unit 17 sets, as the advance angle value θ, the value (α+β) obtained by correcting the reference value α such that the value is greater than the reference value α.

This makes it possible to easily implement the processing for correcting the advance angle value θ based on whether the motor is suddenly accelerating.

In addition, in a state where the control circuit 1 outputs the value obtained by adding the correction value β to the reference value α as the advance angle value θ (=α+β), when the control circuit 1 determines that the rotation speed is stable, the control circuit 1 decreases the correction value β in a stepwise manner.

According to this, when the advance angle value is suddenly decreased in a state where the rotation speed is stable, there is a concern that the operation of the motor will become unstable. However, the control circuit 1 according to the embodiment decreases the correction value β in a stepwise manner as described above, thereby avoiding the operation of the motor 4 from becoming unstable.

### Second Embodiment

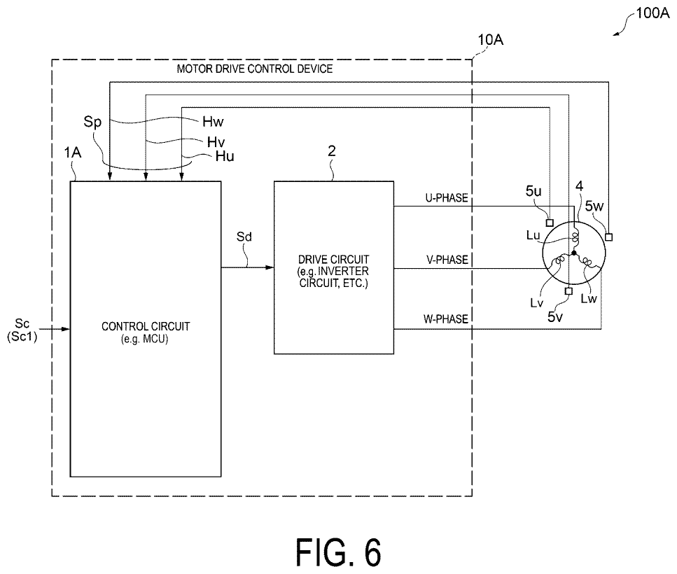

FIG. 6 is a diagram illustrating a configuration of a motor unit 100A equipped with a motor drive control device 10A according to a second embodiment.

The motor unit 100A according to the second embodiment differs from the motor unit 100 according to the first embodiment in that the motor unit 100A includes position sensors 5u, 5v, and 5w, and controls the drive of the motor based on signals detected by the position sensors 5u, 5v, and 5w, but is similar to the motor unit 100 according to the first embodiment in other respects.

As illustrated in FIG. 6, the motor unit 100A includes position sensors 5u, 5v, and 5w instead of the voltage detection circuit 3. The position sensors 5u, 5v, and 5w generate signals Hu, Hv, and Hw corresponding to the rotation of the rotor of the motor 4. The position sensors 5u, 5v, and 5w are, for example, Hall elements. Hereinafter, the position sensors 5u, 5v, and 5w will also be referred to as “Hall elements 5u, 5v, and 5w.”

The three Hall elements 5u, 5v, and 5w are provided corresponding to the phases (U-phase, V-phase, and W-phase) of the motor 4, respectively. The Hall elements 5u, 5v, and 5w are disposed around the rotor of the motor 4 at approximately equal intervals (for example, at intervals of 120 degrees from adjacent elements), for example.

The Hall elements 5u, 5v, and 5w detect the magnetic poles of the rotor, and output signals Hu, Hv, and Hw whose voltages change in accordance with the rotation of the rotor, respectively. The signals Hu, Hv, and Hw are signals indicating the rotational position of the rotor, and are input to the control circuit 1 as position detection signals Sp. Hereinafter, the signals Hu, Hv, and Hw may be collectively referred to as “position detection signals Sp.”

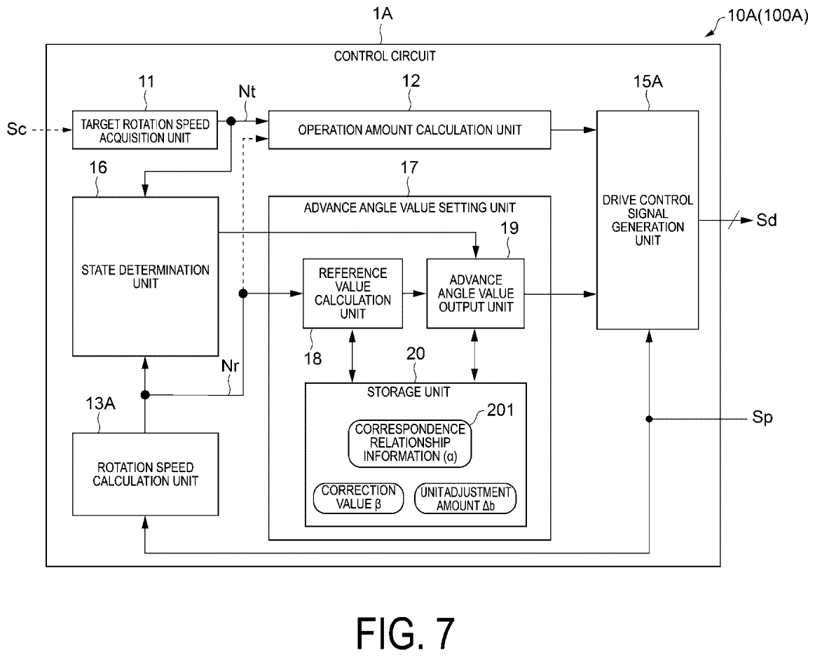

FIG. 7 is a diagram illustrating an example of a functional block configuration of a control circuit 1A according to the second embodiment.

In the control circuit 1A illustrated in FIG. 7, a rotation speed calculation unit 13A calculates the rotation speed Nr using a known calculation method based on the signals Hu, Hv, and Hw as the position detection signal Sp.

In the control circuit 1A, the state determination unit 16 determines the operating state of the motor 4 by the same processing as in the first embodiment using the rotation speed Nr calculated by the rotation speed calculation unit 13A. Based on the determination result of the state determination unit 16, the advance angle value setting unit 17 sets the advance angle value θ by the same processing as in the first embodiment using the rotation speed Nr calculated by the rotation speed calculation unit 13A.

A drive control signal generation unit 15A determines a timing for energization switching between the coils Lu, Lv, and Lw of the motor 4 based on the advance angle value θ set by the advance angle value setting unit 17 and the rotational position of the rotor detected using a known method from the signals Hu, Hv, and Hw as the position detection signal Sp, and outputs the drive control signal Sd based on the determined timing. For example, the drive control signal generation unit 15A outputs the drive control signal Sd such that current is applied to the target coil at a timing when the electrical angle is advanced by the advance angle value θ from the rotational position of the rotor identified by the position detection signal Sp (signals Hu, Hv, and Hw).

This makes it possible for the motor drive control device 10A using a drive control method using position sensors such as Hall elements, to adjust the advance angle value according to the degree of motor acceleration, similarly to the motor drive control device 10 using a sensorless drive control method. Accordingly, since the energization switching between the coils of the motor is performed at an appropriate timing, it is possible to prevent an excessive current from flowing through the coils and damaging the motor and the surrounding electronic components.

### Expansion of Embodiments

The invention made by the present inventor has been specifically described above based on the embodiments, but the present invention is not limited to the embodiments, and it goes without saying that the present invention can be changed in various ways within the scope not departing from the gist of the present invention.

For example, in the above embodiment, an example was given. In the example, respective functional units of the control circuit 1 are implemented by program processing of the MCU, but are not limited to this example, and some or all of the respective functional units of the control circuit 1 may be implemented by a dedicated circuit (hardware).

In addition, the flowchart described above is an example and is not limited to this example. For example, other processing may be inserted between each step or processing may be parallelized.

### REFERENCE SIGNS LIST

100, 100A Motor unit, 10, 10A Motor drive control device, 1, 1A Control circuit, 2 Drive circuit 3 Voltage detection circuit, 4 Motor, 11 Target rotation speed acquisition unit, 12 Operation amount calculation unit, 13, 13A Rotation speed calculation unit, 14 Position detection unit, 15, 15A Drive control signal generation unit, 16 State determination unit, 17 Advance angle value setting unit, 18 Reference value calculation unit, 19 Advance angle value output unit, 20 Storage unit, Md Operation amount, Nt Target rotation speed, Nr Rotation speed, RNt Increase rate of target rotation speed, RNr Increase rate of rotation speed, Sc Drive command signal, Sd Drive control signal, Sp Position detection signal, α Reference value, β Correction value, Δb Unit adjustment amount, θ Advance angle value

1. A motor drive control device, comprising:
a drive circuit configured to drive a motor based on a drive control signal for controlling driving of the motor; and
a control circuit configured to calculate an operation amount of the motor such that the motor rotates at a target rotation speed, set an advance angle value such that the advance angle value increases as a rotation speed of the motor increases, and output the drive control signal according to the operation amount at a timing determined based on the advance angle value and a rotational position of a rotor of the motor,
wherein the control circuit sets a reference value each corresponding to the rotation speed as the advance angle value, and sets a value greater than the reference value as the advance angle value when a degree of increase in the rotation speed satisfies a predetermined condition.

2. The motor drive control device according to claim 1, wherein the control circuit determines that the degree of increase in the rotation speed satisfies the predetermined condition when at least one of a first condition that an increase rate of the target rotation speed is equal to or greater than a first threshold value [[and]]or a second condition that an increase rate of the rotation speed is equal to or greater than a second threshold value is satisfied.

3. The motor drive control device according to claim 1, wherein the control circuit includes:
a target rotation speed acquisition unit configured to acquire the target rotation speed,
a position detection unit configured to detect the rotational position of the rotor,
a rotation speed calculation unit configured to calculate the rotation speed,
a state determination unit configured to determine whether the degree of increase in the rotation speed satisfies the predetermined condition based on at least one of the rotation speed calculated by the rotation speed calculation unit and the target rotation speed,
an operation amount calculation unit configured to calculate the operation amount such that the rotation speed calculated by the rotation speed calculation unit matches the target rotation speed,
an advance angle value setting unit configured to set the advance angle value according to the rotation speed calculated by the rotation speed calculation unit, and
a drive control signal generation unit configured to generate the drive control signal based on the operation amount, determine a timing for energization switching between coils of the motor based on the set advance angle value and the rotational position of the rotor detected by the position detection unit, and output the drive control signal based on the determined timing, and
the advance angle value setting unit sets the reference value corresponding to the rotation speed calculated by the rotation speed calculation unit as the advance angle value when the state determination unit does not determine that the degree of increase in the rotation speed satisfies the predetermined condition, and sets a value corrected to be greater than the reference value as the advance angle value when the state determination unit determines that the degree of increase in the rotation speed satisfies the predetermined condition.

4. The motor drive control device according to claim 3, wherein the advance angle value setting unit includes:
a storage unit configured to store correspondence relationship information indicating a correspondence relationship between the rotation speed and the reference value, and a correction value for correcting the reference value,
a reference value calculation unit configured to calculate the reference value corresponding to the rotation speed calculated by the rotation speed calculation unit based on the correspondence relationship information, and
an advance angle value output unit configured to output the reference value calculated by the reference value calculation unit as the advance angle value when the state determination unit does not determine that the degree of increase in the rotation speed satisfies the predetermined condition, and configured to output a value obtained by adding the correction value stored in the storage unit to the reference value calculated by the reference value calculation unit as the advance angle value when the state determination unit determines that the degree of increase in the rotation speed satisfies the predetermined condition.

5. The motor drive control device according to claim 4, wherein
the state determination unit determines whether the rotation speed is stable, and
the advance angle value output unit decreases the correction value in a stepwise manner when the state determination unit determines that the rotation speed is stable in a state where the advance angle value output unit outputs the value obtained by adding the correction value to the reference value as the advance angle value.

6. A motor unit comprising:
the motor drive control device according to claim 1 and the motor.

7. A motor drive control method, comprising:
a first step of calculating an operation amount of a motor such that the motor rotates at a target rotation speed;
a second step of setting an advance angle value such that the advance angle value increases as a rotation speed of the motor increases; and
a third step of generating a drive control signal for controlling driving of the motor according to the operation amount, and outputting the drive control signal at a timing determined based on the advance angle value and a rotational position of a rotor of the motor,
wherein the second step includes
a fourth step of setting a reference value each corresponding to the rotation speed as the advance angle value, and
a fifth step of setting a value corrected to be greater than the reference value set in the fourth step as the advance angle value when a degree of increase in the rotation speed satisfies a predetermined condition.
